(19) United States
(12) Patent Application Publication
(10) Pub. No.: US 2006/0250359 A1
(43) Pub. Date: Nov. 9, 2006

(54) Computer control mouse having an embedded database storing a plurality of data entries enabled to be repetitively entered into any computer connected to said mouse

(76) Inventors: Dharmesh N. Bhakta, Austin, TX (US); Trung Q. Ly, Austin, TX (US); Juan Francisco Obas, Austin, TX (US); Lakshmi Potluri, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/121,117

(22) Filed: May 3, 2005

(51) Int. Cl. G09G 5/08

(52) U.S. Cl. 345/163

(57) ABSTRACT

An implementation in a computer controlled mouse for storing a plurality of data entries to be repetitively entered into any computer controlled display screen connected to the control mouse combined with means for displaying a menu of items representative of the plurality of stored data entries. There is also an implementation controlled by the mouse for selecting items from the menu combined with means in the mouse for controlling the entry of the selected items at selected positions in display panels on the display screen. The computer will include a function, responsive to the function in the mouse for controlling the entry of selected items, for entering these selected items in said display panels. The function for entering the selected items in said display panels is in the operating system of said computer.

### TECHNICAL FIELD

The present invention relates to user-interactive computer supported display technology, and particularly to such user-interactive systems and methods that provide interactive users with user friendly interfaces for data entry.

### BACKGROUND OF RELATED ART

In the past generation, the data processing industry has been marked by a technological evolution driven by the convergence of the data processing industry with the consumer electronics industry. This advance has been even further accelerated by the extensive consumer and business involvement in the Internet. As a result of these changes, it seems as if virtually all aspects of human endeavor in the industrialized world requires human/computer interfaces. There is a need to make computer directed activities accessible to a substantial portion of the world's population which, up to a few years ago, was computer illiterate or, at best, computer indifferent.

One function that developers of display interfaces have been addressing is ease of use in the entry of data, and particularly the entry of textual data. No matter how intuitive and easy to use an interface may be in its use of icons and related images to make even the novice user feel at home with the interface, in most human/computer transactions a point is reached when the user must enter data, particularly text data. Unfortunately, most people have limited capabilities with the keyboard that still remains the primary means for entering text into a computer display interface. The user is usually slowed down by the entry of text or related data. This is magnified when the user has to enter the same data repetitively. In many systems, each time the user needs to access an independent database or even a function, the user must enter a considerable amount of sign on or access information, e.g. names, addresses, IDs, passwords, phone numbers, account numbers, domain names, e-mail addresses, etc. This is particularly troublesome when the user is browsing via the Internet where it seems that at every level and Web site, at least some of the same information has to be entered again and again and again. The prior art has described systems in which repetitively used data entries have been stored in the same database along with a variety of display pages or forms that use such entries and is then entered into the forms as required. While such systems are effective when both the forms requiring the repetitive data and the data entries themselves are stored in the same database, they have substantially no use for interactive display systems that interface with displayed pages from sources independent of the database entries. This is particularly the situation where the interactive computer display is accessing a wide variety of remote databases through networks, especially the Internet.

U.S. Pat. No. 6,112,215 provides an implementation for processing such multiple entries with a database personalized to the user, but this database still has to be entered into the computer independently. The present invention offers such a system for the processing of repetitive multiple entries that is intuitive to the novice user because the database containing such entries does not have to be independently entered into the computer.

### SUMMARY OF THE PRESENT INVENTION

The present invention provides a solution to the above-described needs through a user activated cursor control mouse connected to said computer controlling a user-interactive display having a graphical user interface (GUI). The mouse is conventionally movable in the four orthogonal directions, and is combined with conventional means in the computer for converting said user activated orthogonal movements into cursor movements in the four orthogonal directions on said display screen. In this invention, there are means in the mouse for storing a plurality of data entries to be repetitively entered into any computer controlled display screen connected to the control mouse combined with means for displaying a menu of items representative of the plurality of stored data entries. There also are means controlled by the mouse for selecting items from said menu combined with means in the mouse for controlling the entry of the selected items at selected positions in display panels on the display screen. The computer will include means, responsive to the means in the mouse for controlling the entry of selected items, for entering these selected items into the display panels. The means for entering the selected items into the display panels are in the operating system of said computer.

The means in the mouse for storing the plurality of data entries to be repetitively entered may conveniently be a flash memory.

The control mouse may be interchangeable, i.e. connectable to another computer controlled interactive display whereby the menu may be displayed on the other display. Also, the mouse may include a thumb wheel for controlling the scrolling through the displayed menu of items.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system with the control mouse with storage for a plurality of data entries to be repetitively entered into any computer controlled display screen connected to the control mouse used in practicing the present invention;

FIG. 2 is a diagrammatic view of a display screen illustrating dialog panels used to solicit personalized data from a user to be used for the repetitive data entries stored in the contol mouse;

FIG. 3 is the diagrammatic display view of a document into which selected stored entries are to be entered with a superimposed menu of repetitive entries stored in the control mouse;

FIG. 4 is a flowchart of the program steps involved in setting up a system for storing in the control mouse, data entries to be repetitively entered into any computer controlled display screen connected to the control mouse; and

FIG. 5 is a flowchart of the steps involved in applying the system of the present invention in a data entry session.

### DETAILED DESCRIPTION OF THE PREFERRED EMBODIMENT

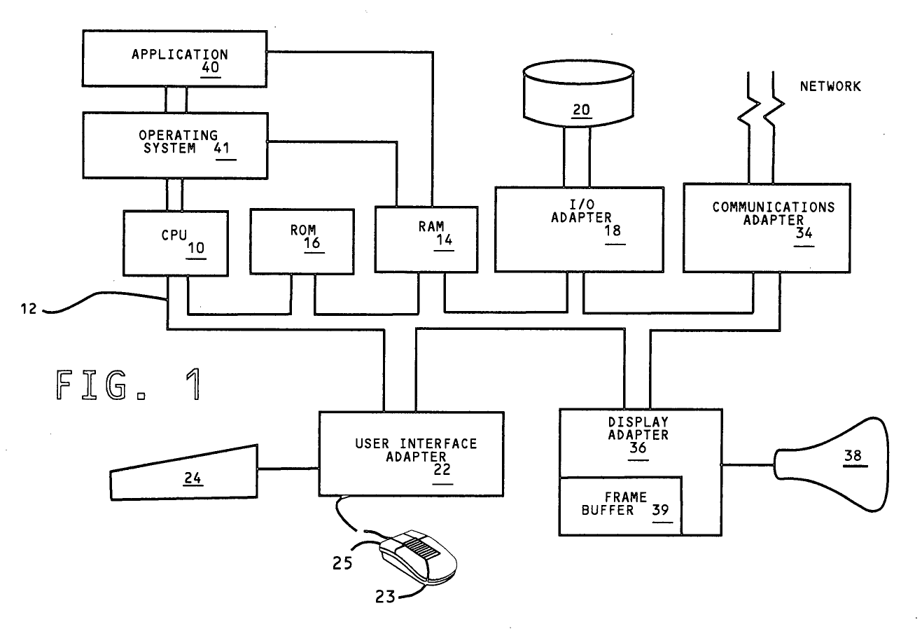

Referring to FIG. 1, a typical data processing system is shown that may function as the computer controlled display terminal used in implementing the system of the present invention for storing in the control mouse, data entries to be repetitively entered into any computer controlled display screen connected to the control mouse.

A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows 2000™ or Windows Millenium™, as well as UNIX or IBM's AIX operating systems. An application program that controls storing in the control mouse data entries to be repetitively entered into any computer controlled display screen connected to the control mouse 25, to be subsequently described in detail, runs in conjunction with operating system 41 and provides output calls to the operating system 41; which, in turn, implements the various functions to be performed by the application 40. The mouse 25 includes a scrolling aid, such as a scroll or thumb wheel 23, that may be used for the convenience of scrolling through a displayed menu. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or Wide Area Network (WAN); which includes, of course, the Internet or World Wide Web (Web). I/O devices are also connected to system bus 12 via user interface adapter 22 and display adapter 36. Keyboard 24 and mouse 23 are interconnected to bus 12 through user interface adapter 22.

Mouse 23 operates in a conventional manner insofar as orthogonal user movement is concerned. However, it contains memory for the storage of data entries to be repetitively entered into any computer controlled display screen connected to the control mouse. This invention has become commercially practical because of the lower and lower cost of such memory. At the current technology stage, such memory may be embedded in the control mouse to provide a supplementary memory capacity of from one-half to five gigabytes. The flash memory is based upon EEPROM (electrically erasable programmable read only memory) grid chips. Such Flash memory EEPROM works much faster than conventional EEPROM.

Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the control mouse conventionally, a user is capable of inputting information to the system through the keyboard 24 or mouse 26 and receiving output information from the system via display 38.

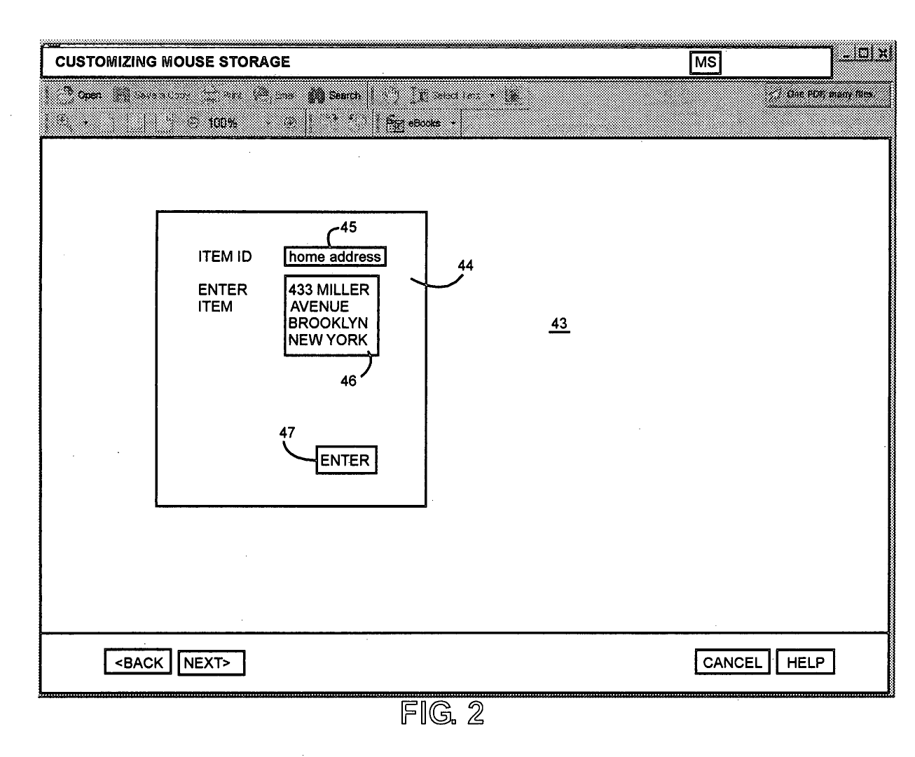

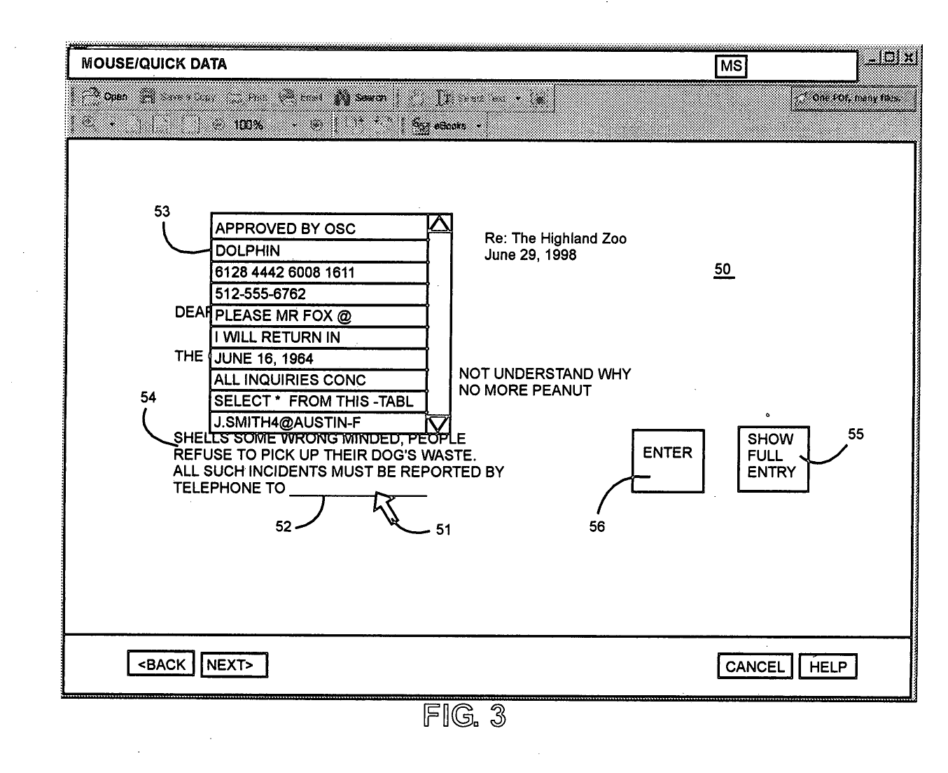

There will now be described a simple illustration of the present invention with respect to the display screens of FIGS. 2 and 3. When the screen images are described, it will be understood that these may be rendered by storing image and text creation programs, such as those in any conventional window operating system in the RAM 14 of the system of FIG. 1. The operating system is diagrammatically shown in FIG. 1 as operating system 41. The display screens of FIGS. 2 and 3 are presented to the viewer on display monitor 38 of FIG. 1. In accordance with conventional techniques, the user may control the screen interactively through the mouse 25 of FIG. 1 that operates through user interface 22 to call upon programs in RAM 14 cooperating with the operating system 41 to create the images in frame buffer 39 of display adapter 36 to control the display on monitor 38. The initial display screen of FIG. 2 shows a display screen 43 that typifies data entry screens to be used in the present invention to enter the repetitive data that is to be stored in the control mouse. The user is being prompted through dialog box 44 to enter some typical data to be repetitively used via a prompt for an identification 45 of the item to be entered and the item of data entry 46 to be stored in the contol mouse memory. Upon completion of that particular entry, the user hits the entry button via mouse controlled cursor and that item is stored in the mouse memory. Then, the next dialog box for soliciting additional data entry to be stored in the mouse is brought up.

Now, with respect to FIG. 3, there will be described how data entry items stored in the control mouse memory may be displayed, selected and entered into an illustrative document 54 on display screen 50. The user needs to enter some information that the user has needed to enter on many past occassions into many other documents. Thus, cursor 51 under control of the mouse is moved to entry point 52 and then brings up repetitive entry menu 53 representative of the items stored on the control mouse. The desired entry may be scrolled to into scrollable menu through conventional mouse controlled movement, the item from menu 53 selected and entered at point 52 of document 54 by hitting enter button 56. In some cases, the stored entry to be made may be longer than the display space available for the item in menu 53. In such a case, the user may select Show Full Entry button 55 and the full entry for an item in menu 53 will be shown.

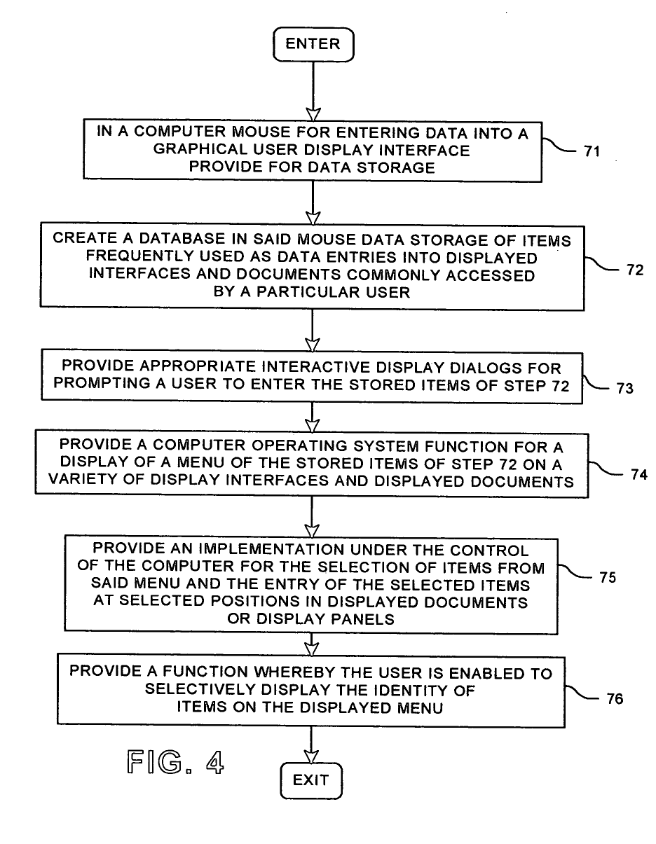

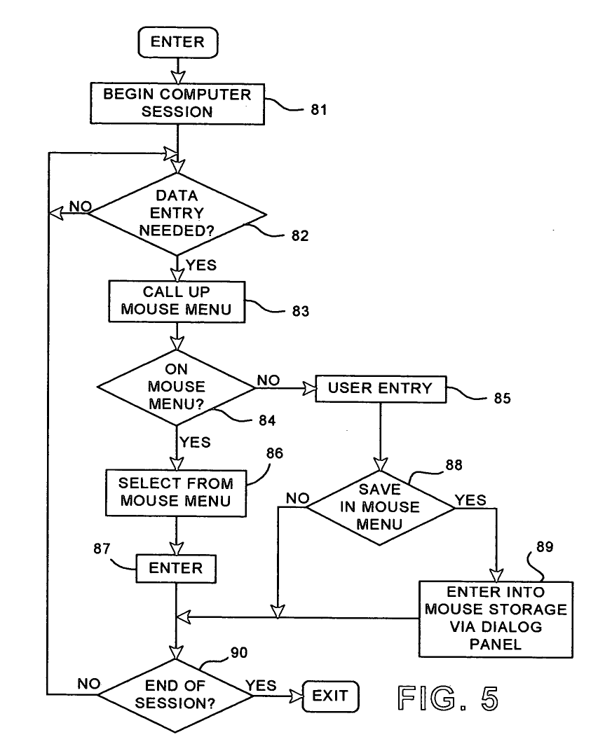

Now, with reference to FIGS. 4 and 5, we will describe a process implemented by the present invention in conjunction with the flowcharts of these figures. FIG. 4 is a flowchart showing the development of a process according to the present invention for storing in the control mouse, data entries to be repetitively entered into any computer controlled display screen connected to the control mouse. Storage is provided in a computer mouse used for entering data into a GUI, step 71. A database is created in the mouse storage of items frequently used as data entries into displayed interfaces and documents commonly accessed by the user, step 72. By documents that the present invention may interface are included any text configuration into which data is to be entered through a display interface. Appropriate interactive display interfaces are provided for prompting a user to enter used items of data entry, step 73, so that they may be used in the database of step 72. A computer operating system function is provided, step 74, for displaying a menu of the stored items of step 72 on a variety of displayed interfaces and document interfaces. It should be noted that the operating system of the computer controls the display of the stored items in menus. Thus, an implementation is provided under the control of the computer operating system, for the display of the items stored in the mouse and the entry of the selected items at selected positions in displayed documents or like display screen panels, step 75. It should be noted that the display of the menus in display interfaces provided by various computer operating systems may be provided by appropriate mouse drivers already in the computer operating system. A function is provided whereby the user is enabled to selectively display the identity of items on the displayed menu, step 76.

The running of the process will now be described with respect to FIG. 5. First, step 81, the session is commenced. A determination is made as to whether a data entry is required, step 82. If No, session processing continues. If Yes, the menu of items stored in the mouse is displayed, step 83. A determination is made as to whether the item is on the mouse menu, step 84. If Yes, an appropriate selection is made from the mouse menu, step 86, and entered, step 87, at an appropriate data entry point in the document displayed. If No, the user enters the entry through the keyboard, step 85, and is prompted as to whether the entered item is repetitive enough that he wishes to save the item on his mouse storage, decision box 88. If Yes, the item is entered into storage via a dialog panel on screen, step 89. Then, or after step 1, or if the decision in step 88 is No, a determination is made, step 90, as to whether the session is at an end. If Yes, it is exited. If No, the process is returned to step 82, and continued.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user interactive display having a graphical user interface a system for controlling data entry on the display screen comprising:
a user activated cursor control mouse connected to said computer movable in the four orthogonal directions;
means in said computer for converting said user activated orthogonal movements into cursor movements in said four orthogonal directions on said display screen;
means in said mouse for storing a plurality of data entries to be repetitively entered into any computer controlled display screen connected to said control mouse;
means for displaying a menu of items representative of said plurality of stored data entries;
means controlled by said mouse for selecting items from said menu; and
means in said mouse for controlling the entry of said selected items at selected positions in display panels on said display screen.

2. The system for controlling the data entry of claim 1, further including at least one other computer controlled interactive display wherein said control mouse is connectable to said other computer controlled interactive display, and said menu may be displayed on said other display.

3. The system for controlling the data entry of claim 1, wherein said mouse further includes a thumb wheel for controlling the scrolling through said displyed menu of items.

4. The system for controlling the data entry of claim 1, wherein said computer further includes means, responsive to said means in said mouse for controlling said entry of selected items, for entering said selected items in said display panels.

5. The system for controlling the data entry of claim 4 wherein said means for entering said selected items in said display panels are in the operating system of said computer.

6. The system for controlling the data entry of claim 4 wherein the means in said mouse for storing said data entries includes a flash memory.

7. A user activated cursor control mouse movable in the four orthogonal directions, connectable to a user interactive display having a graphical user interface, comprising:
means for storing a plurality of data entries to be repetitively entered into any computer controlled display screen connected to said control mouse;
means for controlling the display on said display of a menu of items representative of said plurality of stored data entries;
means for selecting items from said menu; and
means for controlling the entry of said selected items at selected positions in display panels on said display screen.

8. The user activated cursor control mouse of claim 7 further including a thumb wheel for controlling the scrolling through said displyed menu of items.

9. The user activated cursor control mouse of claim 7 wherein the means in said mouse for storing said data entries includes a flash memory.

10. In a computer controlled user-interactive display having a graphical user interface with a user activated cursor control mouse connected to said computer movable in the four orthogonal directions, a method for controlling data entry on the display screen comprising:
converting said user activated orthogonal movements into cursor movements in said four orthogonal directions on said display screen;
storing in said mouse a plurality of data entries to be repetitively entered into any computer controlled display screen connected to said control mouse;
displaying under control of said mouse a menu of items representative of said plurality of stored data entries;
selecting, under control of said mouse items from said menu; and
controlling through said mouse, the entry of said selected items at selected positions in documents displayed of said display screen.

11. The method for controlling the data entry of claim 10, further including the step of connecting the control mouse to at least one other computer controlled interactive display whereby said menu may be displayed on said other display.

12. The method for controlling the data entry of claim 10 further including the step in said display, responsive to said step in said mouse of controlling said entry of selected items, for entering said selected items in said displayed documents.

13. The method for controlling data entry of claim 10 wherein said plurality of stored data entries are unrelated to each other.

14. A computer program having data structures included on a computer readable medium for controlling data entry into a user-interactive graphical user interface on a computer controlled display screen comprising:
a user activated cursor control mouse connected to said computer movable in the four orthogonal directions, means in said computer for converting said user activated orthogonal movements into cursor movements in said four orthogonal directions on said display screen;
means in said mouse for storing a plurality of data entries to be repetitively entered into any computer controlled display screen connected to said control mouse;
means for displaying a menu of items representative of said plurality of stored data entries, means controlled by said mouse for selecting items from said menu; and
means in said mouse for controlling the entry of said selected items at selected positions in documents displayed on said display screen.

15. The computer program for controlling data entry of claim 14, further including at least one other computer controlled interactive display wherein said control mouse is connectable to said other computer controlled interactive display and said menu may be displayed on said other display.

16. The computer program for controlling the data entry of claim 14, wherein said mouse further includes a thumb wheel for controlling the scrolling through said displyed menu of items.

17. The computer program for controlling the data entry of claim 14, wherein said computer further includes means, responsive to said means in said mouse for controlling said entry of selected items, for entering said selected items in said displayed documents.

18. The computer program for controlling data entry of claim 17 wherein said means for entering said selected items in said displayed documents are in the operating system of said computer.

19. The computer program for controlling the data entry of claim 17 wherein the means in said mouse for storing said data entries includes a flash memory.

20. The computer program for controlling data entry of claim 14 wherein said plurality of stored data entries are unrelated to each other.
